(19) United States
(12) Patent Application Publication
(10) Pub. No.: US 2015/0004574 A1
(43) Pub. Date: Jan. 1, 2015

(54) Prioritizing Method of Operator Coaching On Industrial Machines

(71) Applicant: Caterpillar Inc., Peoria, IL (US)

(72) Inventors: Bradley K. Bomer, Perkin, IL (US); Zhijun Cai, Springfield, IL (US); Carl Darukhanavala, Peoria, IL (US); Vardhaman Lakhani, Chicago, IL (US); Kevin Dluzen, Peoria, IL (US); Jeffrey Fletcher, Peoria, IL (US); Drew Fehr, Washington, IL (US); Owen Kolstad, Peoria, IL (US)

(21) Appl. No.: 13/929,433

(22) Filed: Jun. 27, 2013

(51) Int. Cl. G09B 19/00

(52) U.S. Cl. CPC G09B 19/00
USPC 434/219

(57) ABSTRACT

A system and method for coaching an operator of an industrial machine improves operator skill levels by providing prioritized coaching to the operator. The system and method identify operations performed during the work session and compare each operation to a model of the operation to identify operations that differ substantially from the model. Each such operation is logged as a coaching opportunity, and the method and system prioritize the associated coaching sequences for presentation to the operator, e.g., based on (1) classification of the operation associated with each coaching opportunity; (2) significance of the operation associated with each coaching opportunity; (3) operator history; (4) manager preferences; and (5) error severity.

### FIELD OF THE DISCLOSURE

The present disclosure relates generally to earthmoving, industrial and agricultural machines (herein, “industrial machines” collectively) and, more particularly, to systems and methods for coaching an operator of an industrial machine after the performance of a plurality of operations.

### BACKGROUND OF THE DISCLOSURE

Industrial machines provide significant efficiencies over older methods of digging, moving, spreading, transporting or otherwise working with materials. Such machines include, but are not limited to, wheel loaders, track-type tractors, motor graders, excavators, articulated trucks, pipe layers, backhoes, and the like. These machines typically require significant skill to operate efficiently, and as such, operators of such machines must generally undergo extensive training before operating the machine.

Nonetheless, the physical operation of these types of machines by the operator presents a different experience than that provided through training with other means, and as such, there still exists the potential for errors when an operator performs actual operations with the machine. For example, a user may not remember, or may not have learned, how to perform a particular operation. Generally, each operation may have an ideal or expected model, e.g., a sequence of events and series of parameters designed to most efficiently execute the operation. While the operator will likely execute any given operation to completion, he or she may not have done so in the most efficient manner. In particular, failure to follow the model operating method may lower machine performance, reduce fuel efficiency, or cause other undesirable effects.

One attempted solution has been to create a system that generates a simulated environment of a worksite. For example, U.S. Pat. No. 8,139,108, entitled “Simulation System Implementing Real-Time Machine Data” and assigned to Caterpillar Inc., describes such a system. The system of the '108 patent describes a simulation system that uses real-time performance data to remotely simulate operation of a machine at a worksite. Once a controller of the system of the '108 patent generates a simulated 3-D environment of the worksite, the operator can control and move the machine about the virtual worksite.

Nonetheless, opportunities still exist for improvement in operator training through coaching. The present disclosure is directed to a system that employs a type of coaching to further improve operator skill levels. However, it should be appreciated that the solution of any existing problem is not a limitation on the scope of this disclosure or of the attached claims except to the extent expressly noted. Additionally, this background section discusses observations made by the inventors; the inclusion of any observation in this section is not an indication that the observation represents known prior art except that the contents of the indicated patent represent a publication. With respect to the identified patent, the foregoing summary thereof is not intended to alter, supplement, or expand upon the patent; any discrepancy or difference should be resolved by reference to the patent document itself.

### SUMMARY OF THE DISCLOSURE

In accordance with one aspect of the present disclosure, a method is provided for coaching an operator of a machine having a controller in communication with a plurality of sensors. Each configured to provide a data signal for a parameter associated with an operation of the machine. An operator interface is included to provide operator signals for manipulating the machine. In this aspect, the method includes receiving a data signal from one or more of the sensors and receiving one or more operator signals from the operator interface. The controller identifies the machine operation performed based on the received data signals and the received operator signals. By comparing the received data signals and the received operator signals with expected data signals and operator signals for the operation based on a model of the operation, the controller may identifies the operation as a coaching opportunity. A priority is then assigned to each coaching opportunity for later presentation to the operator.

In accordance with another aspect of the present disclosure, a system is provided for coaching an operator of an industrial machine. The system includes a plurality of sensors associated with the machine, with each sensor being configured to generate a machine data signal indicative of the operation of an element of the machine. The system further includes an output device configured to present information to an operator of the machine. A controller in communication with the output device and the sensors is configured to receive the machine data signals and identify a machine operation, compare the received machine data signals to expected machine data associated with a model of the operation, identify the operation as having been erroneously performed based on the comparison, and record the erroneously performed operation as a coaching opportunity. A priority is assigned to each of the coaching opportunities and coaching material associated with each coaching opportunity are presented via the output device in an order defined by the assigned priorities.

In accordance with yet another aspect of the present disclosure, a non-transitory computer-readable medium is provided having stored thereon computer-executable instructions for coaching an operator of a machine in the performance of a machine operation. The machine has a controller in communication with a plurality of sensors, each sensor being configured to provide a data signal indicative of a parameter associated with an operation of the machine. The machine also includes an operator interface configured to provide operator signals for manipulating the machine. Within this context, the computer-executable instructions include instructions for receiving a data signal from one or more of the sensors, receiving one or more operator signals from the operator interface, identifying a machine operation performed based on the received data signals and the received operator signals, and comparing the received data signals and the received operator signals with expected data signals and operator signals for the operation based on a model of the operation. The operation is identified as a coaching opportunity based on the comparison, and a priority is assigned to each coaching opportunity. Coaching materials associated with each coaching opportunity are presented to the user in an order defined by the assigned priority once the work session involving the machine has ended.

These and other aspects and features of the disclosure will become more readily apparent upon reading the following detailed description when taken in conjunction with the accompanying drawings.

Although various features are disclosed in relation to specific embodiments, it should be understood that the various features may be combined with each other, or used alone, with any of the various exemplary embodiments of the invention without departing from the scope of the disclosed principles.

### BRIEF DESCRIPTION OF THE DRAWINGS

FIG. 1 is a perspective view of an excavator within which embodiments of the disclosed principles may be implemented;

FIG. 2 is a perspective view of a track-type tractor within which embodiments of the disclosed principles may be implemented;

FIG. 3 is a perspective view of a wheel loader within which embodiments of the disclosed principles may be implemented;

FIG. 4 is a perspective view of an articulated truck within which embodiments of the disclosed principles may be implemented;

FIG. 5 is a block diagram of a system for coaching an operator according to an embodiment of the disclosure;

FIG. 6 is a schematic view of a display of the system for coaching an operator of a wheel loader, according to an embodiment of the disclosure;

FIG. 7 is a block diagram of a system for coaching an operator according to another embodiment of the present disclosure;

FIG. 8 is a flowchart illustrating a method for coaching an operator of a machine according to an embodiment of the present disclosure; and

FIG. 9 is a flow chart of a process for presenting coaching materials to a machine operator in accordance with an aspect of the disclosed principles.

While the present disclosure is susceptible to various modifications and alternative constructions, certain illustrative embodiments thereof are shown and described below in detail. The scope of the disclosed principles is not limited to the specific embodiments discussed herein, but instead includes all modifications, alternative constructions, and equivalents thereof.

### DETAILED DESCRIPTION

The present disclosure provides a system and method for coaching an operator of an industrial machine. The disclosed system and method act to improve operator skill levels by providing prioritized coaching to the operator of the machine after the performance of a number of operations, that is, after a work session. The system and method monitor the machine activity during performance of operations, e.g., to identify machine conditions and parameters (referred to as “machine data,” including speed, bucket angle, articulation angle, gear, engine rpm, hydraulic pressures, etc.), as well as operator inputs (actual machine data and actual operator inputs being collectively referred to as “actual data”), and determine a type of operation being performed. The system and method then compare the actual data to expected data according to a model of the operation in question.

To the extent that the actual data differ from the expected data for that operation, the method and system log the operation as a coaching opportunity. In an embodiment, actual data that differs only by less than a predetermined tolerance from the expected data is not deemed to differ for purposes of the disclosed system and method. When a plurality of such opportunities have been logged, the method and system prioritize associated coaching sequences for presentation to the operator at a later time, e.g., after the work session when the engine of the machine is idle and the machine is stopped and in a neutral gear. Alternatively, the coaching materials may be presented to the operator at the start of another work session.

In an embodiment, the system prioritizes the coaching materials presented based on (1) classification of the operation associated with each coaching opportunity; (2) significance of the operation associated with each coaching opportunity; (3) operator history (including, for example, operator skill level, flagged coaching points, productivity and efficiency); (4) manager preferences; and (5) error severity. The operation classification may be based on operational productivity, fuel efficiency, operator safety, etc. The significance of an operation may be based on the gains expected in productivity, efficiency, etc. when the model is followed. The factor of history, or “coaching history,” reflects the training already conducted with the operator for a specific operation and the time elapsed since the last training with respect to that operation.

The factor of manager preferences allows a manager to override other factors and accord a higher priority to one or more specific operations. For example, the manager may emphasize fuel efficiency over operational productivity or vice versa. The factor of severity may be based on the number of triggering events for a specific operation.

Each coaching sequence may include a simulation, a recorded video, a text, an automated demonstration onboard the machine, an audio description, and/or other coaching material used to apprise the operator of the model procedure of a given operation.

Further to the foregoing overview, reference is now made to specific embodiments or features, examples of which are illustrated in the accompanying drawings. Generally, corresponding reference numbers will be used throughout the drawings to refer to the same or corresponding parts.

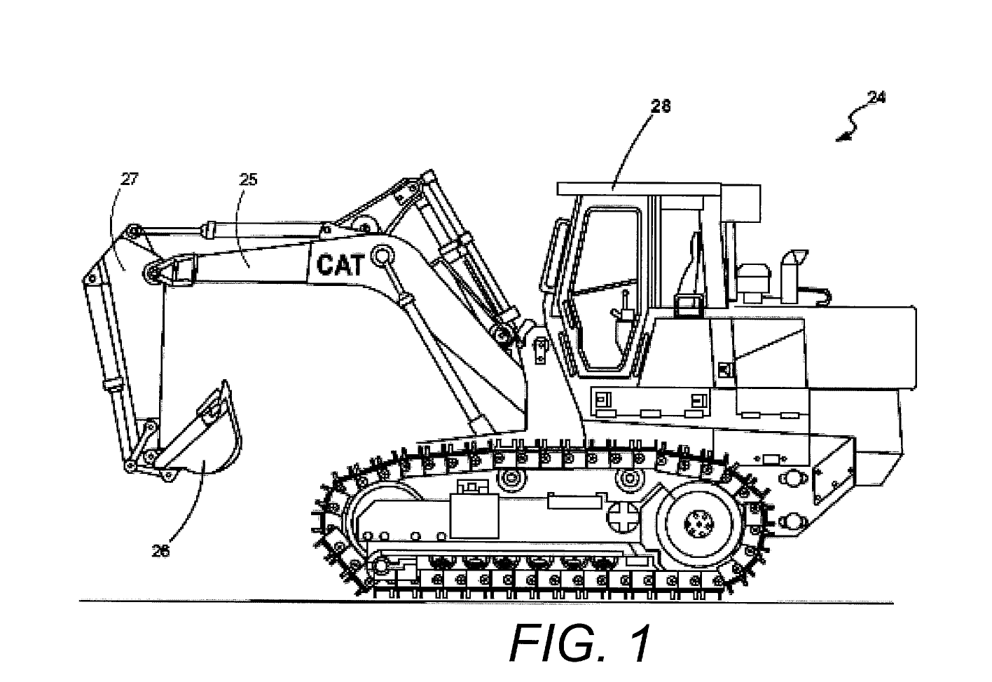

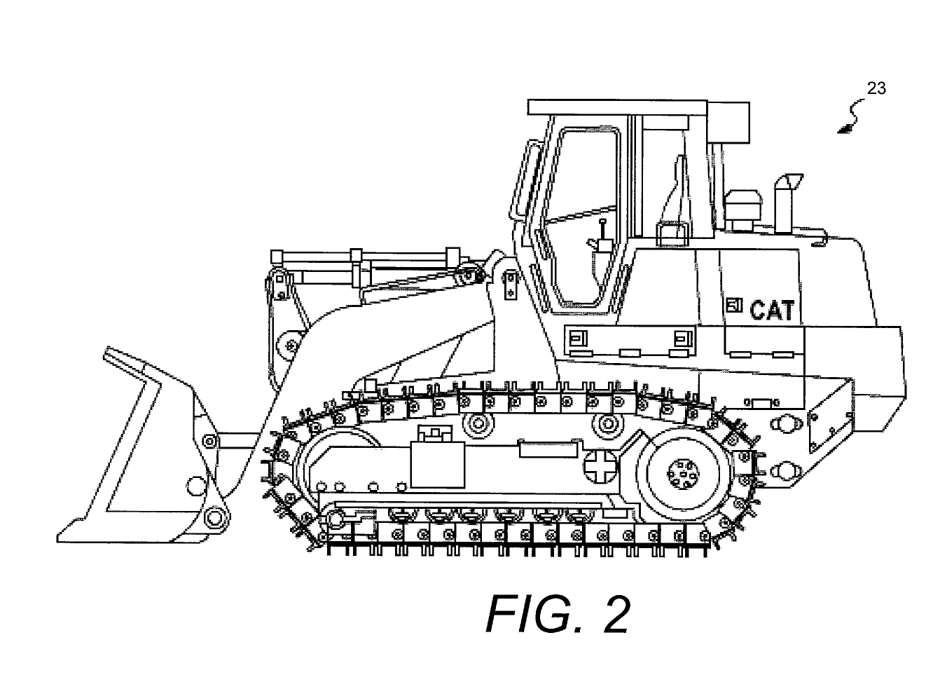

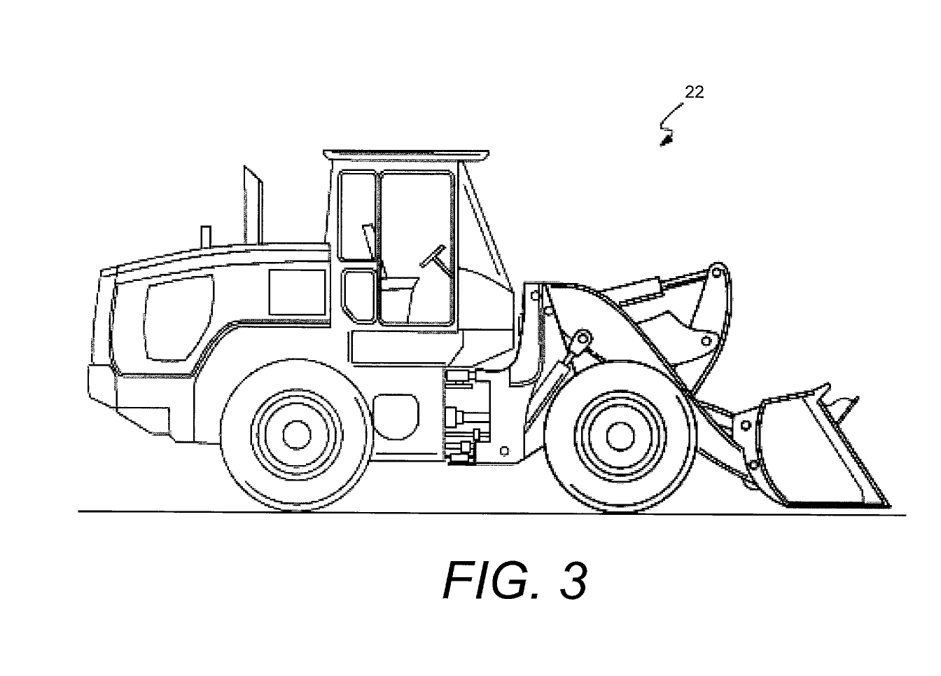

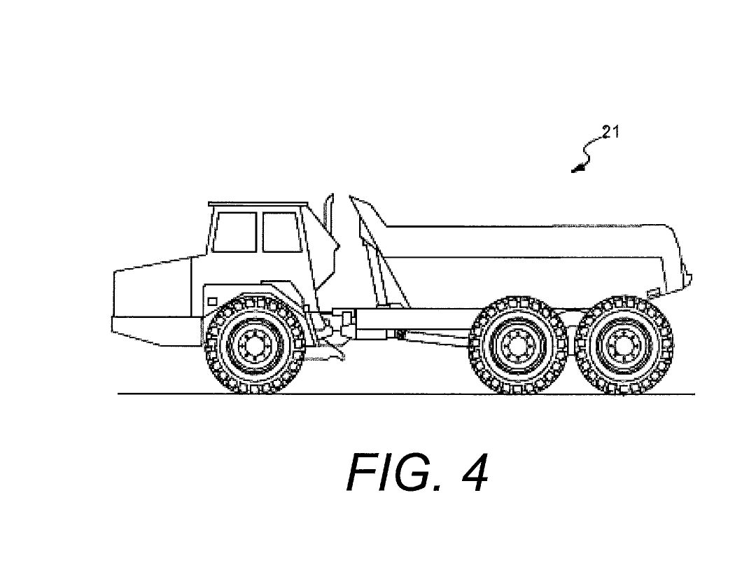

Turning now to the figures, although the examples herein may be described by reference to a specific machine such as a wheel loader 22 (FIG. 3), it will be understood that in other embodiments, the machine may be any other type of machine or vehicle, used in earthmoving, industrial or agricultural applications. For example, a machine used to implement the disclosed principles may be, without limitation, an excavator 24 as shown in FIG. 1, a track-type tractor 23 as shown in FIG. 2, a wheel loader 22 as shown in FIG. 3, an articulated truck 21 as shown in FIG. 4, or, alternatively, a motor grader, pipe layer, backhoe, or the like (not shown). It is also to be understood that each machine 21-24 is shown primarily for illustrative purposes to assist in understanding the features of the various embodiments, and that FIGS. 1-4 do not depict all of the components of an exemplary machine.

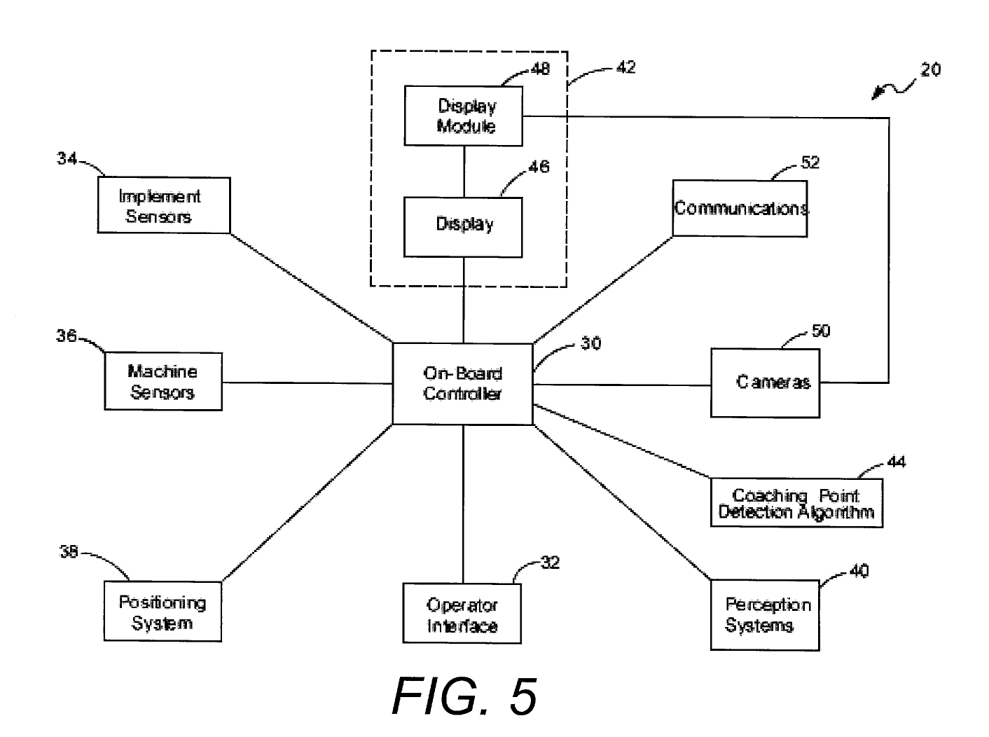

In an embodiment shown in FIG. 5, a machine coaching system 20 comprises a controller 30 in communication with an input device or operator interface 32, implement sensors 34, machine sensors 36, positioning system 38, perception systems 40, and output device 42, all of which may be on-board the machine 22. The controller 30 comprises a microprocessor-based computing device in an embodiment, having computer-executable instructions and associated data stored on a non-transitory computer readable medium associated with the controller 30.

The controller 30 receives input from the operator through the operator interface 32, which may include one or more joysticks, steering wheels, pedals, keyboards, touchscreens, displays, or the like, for manipulation of the machine 22. The implement sensors 36 may comprise sensors configured to measure implement or tool position, load pressure, pin angle, actuator displacement, and the like. The machine sensors 36 include one or more sensors configured to measure machine speed, engine speed, transmission gear, steering angle, articulation angle, and the like as may be relevant to one or more operations of the machine 22.

The positioning system 38 identifies a current location, time and/or position of the machine 22 and may comprise a navigation system which uses, for example, the global positioning system (GPS), an inertial measurement unit (IMU), a dead reckoning procedure, perception-based localization (PBL), or a combination thereof.

As noted above, the coaching system 20 also comprises on-board and off-board perception systems 40, e.g., to detect objects, personnel, or other machines close to the machine 22. The perception systems 40 may use radar, lidar, cameras, or a combination thereof for object and personnel detection. The output device 42 may include one or more displays, monitors, screens, touchscreens, lights, speakers, buzzers, or the like, for providing information from the system 20 to the operator.

Algorithms or sets of instructions for monitoring the operation of the machine 22 performed by the operator may be preprogrammed into a memory of the controller 30 or downloaded to the controller 30. More specifically, through such computer-executable instructions, the controller 30 is configured to identify a type of operation performed (e.g., a dig to dump cycle) based on collected machine data and user input. The parameters of different types of operations, each being identified by a particular series of machine actions, may be programmed into the memory associated with the controller 30.

The controller 30 analyzes the data received from the operator interface 32, implement sensors 34, machine sensors 36, positioning system 38, and/or perception systems 40 in order to identify each operation that the machine 22 performs. In an example wherein the machine 22 is a wheel loader, the controller 30 can determine a location of the machine 22 relative to a pile based on signals sent by the positioning system 38 and the perception systems 40; from signals sent by the machine sensors 36, the controller 30 can determine that the machine 22 is driving into the pile and can determine the extent to which the operator raises the bucket when resistance is encountered (e.g., by sensing hydraulic pressure); from signals sent by the operator interface 32, the controller 30 can further determine commands indicative of raising the bucket to set the wheels. Based on the collection of gathered data, the controller 30 can detect that the machine 22 is digging into a pile.

The controller 30 is also configured to execute, among other things, a coaching point detection algorithm 44. The coaching point detection algorithm 44 detects a coaching point, or a specific action to monitor during the operation. Expert operators and trainers may identify coaching points based on common practices of novice operators who need coaching to perform the specific action in an efficient or safe manner, or to achieve an optimal performance of the machine 22. For example, digging into a pile may be a coaching point so that the operator can be coached to raise the bucket to set the machine wheels during such as operation.

More generally, examples of coaching points include, for example, (1) minimizing unnecessary linkage motion, (2) minimizing frame articulation in a wheel loader 22 while digging into a pile, (3) assuring wheel set in a wheel loader 22 or similar machine, while digging into a pile, (4) assuring that the operator maintains a linkage position within an efficient range (e.g., stick 27 is within mechanical advantage parameters during dig, depth of a cut, and digging in layers) when operating an excavator 24, (5) minimizing excavator 24 rocking on uneven ground during dig and swing, and (6) not blowing hydraulic release for the stick 27, bucket 26, boom 25, and swing for an excavator 24. There may be many coaching points of interest, each coaching point having a detection algorithm to detect when the coaching point occurs during the operation. During an operation, the controller 30 may be checking for more than one coaching point.

In addition, as noted above, coaching points may vary depending on the particular machine being used. For example, coaching points for the wheel loader 22 (FIG. 3) may be, without limitation, no articulation during dig, setting tires properly, loading with lift using bucket curl, proper bucket angle during dig, and loading the bucket 26 without using back and forth articulation. A coaching point for the articulated truck 21 (FIG. 4) may be positioning of the articulated truck 21 relative to a load location, while a coaching point for a track-type tractor 23 (FIG. 2) may be proper gear usage when dozing and push loading. Other coaching points may be used additionally or alternatively.

Expected data for each coaching point, such as a predetermined set of parameters in accordance with an model operating method for the coaching point, may be included in the coaching point detection algorithm 44 preprogrammed into the memory associated with the controller 30. The controller 30 then compares actual data during an operation (e.g., sent from the operator interface 32, implement sensors 34, machine sensors 36, positioning system 38, and perception systems 40) to the expected data for the coaching point. Through output device 42, the controller 30 may later coach the operator regarding his or her performance based on operation priority as noted above.

With respect to determining whether a coaching point gives rise to a coaching opportunity, any number of techniques may be used. In an embodiment, if the actual data during a coaching point is not within a predefined margin of error of the expected data, then it is determined that the operator is not performing according to the model operating method for the coaching point, and the controller 30 may then define the operation or portion thereof as a coaching opportunity, that is, a non-conforming or coachable action needing improvement. If the actual data is within the margin of error of the expected data, then the operator is deemed to have performed according to the model operating method for the coaching point, and the controller 30 may signal a conforming action.

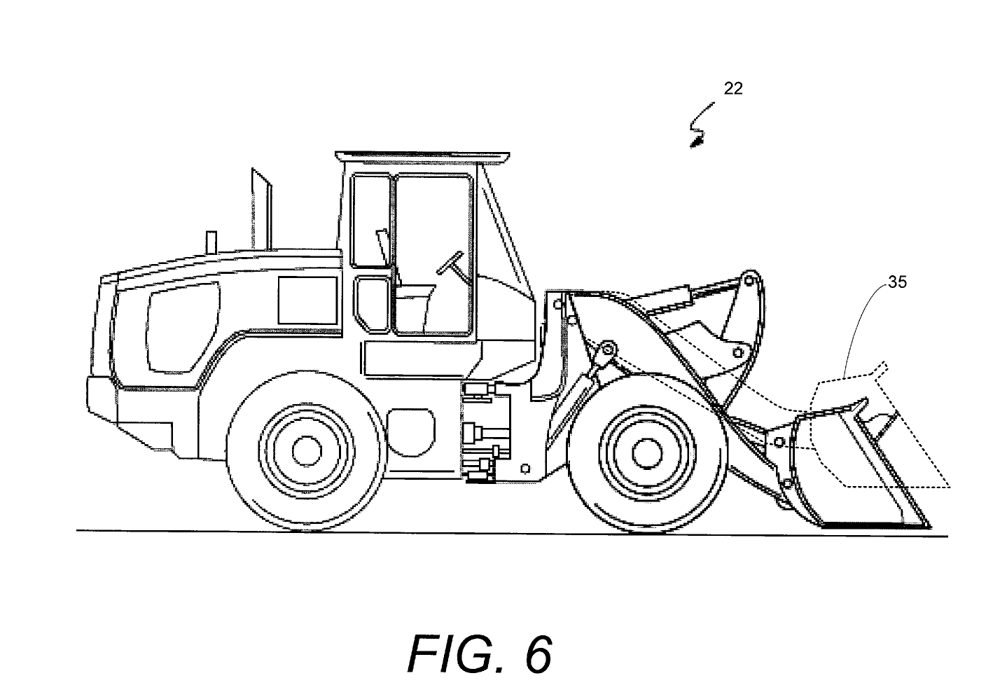

For instance, in the coaching point example shown in FIG. 6, related to the example operation of a wheel loader digging into a pile, the model operation may comprise entering the pile with the bucket level and at height zero or close to zero, followed by raising the bucket when resistance to forward movement is encountered. This is referred to as “setting” the wheels, in that it increases the downward force on the wheel loader's wheels and thus prevents wheel spinning as the bucket is driven further into the pile.

When the controller 30 determines that the wheel loader 22 is performing an operation of digging into a pile, the coaching point detection algorithm 44 analyzes the actual performance of the operation. The coaching point detection algorithm 44, for example, may compare certain salient factors and parameters to determine whether the performance constitutes a coaching opportunity. In the given example, by monitoring the bucket lift cylinder pressure, the coaching point detection algorithm 44 can determine whether the operator appropriately raised the bucket to set the wheels upon encountering resistance.

Assuming the operator has failed to raise the bucket to set the wheels during the operation, the operation is noted as a coaching opportunity for later coaching. After the work session, coaching material for this operation is presented in its place in the prioritized listing of such opportunities. The materials presented may include a graphical representation of the wheel loader as shown schematically in FIG. 6, for example, showing the operator the appropriate amount by which to raise the bucket.

In the illustrated example, the amount of lift is shown via a dotted outline 35 of the raised position. However, other graphical methods may be used, including an illustration of control inputs, an animation, etc.

To provide such a display, the controller 30 is communicatively linked with a display 46 (e.g., output device 42) and a display module 48. The display 46 may comprise a screen, touch screen, monitor, or the like, for displaying images. The display module 48 is processor-based and may be implemented via controller 30 or may comprise a separate controller or microprocessor. Furthermore, the display 46 and display module 48 may or may not be part of the machine 22. The display 46 may be provided within a cab 28 of the machine 22.

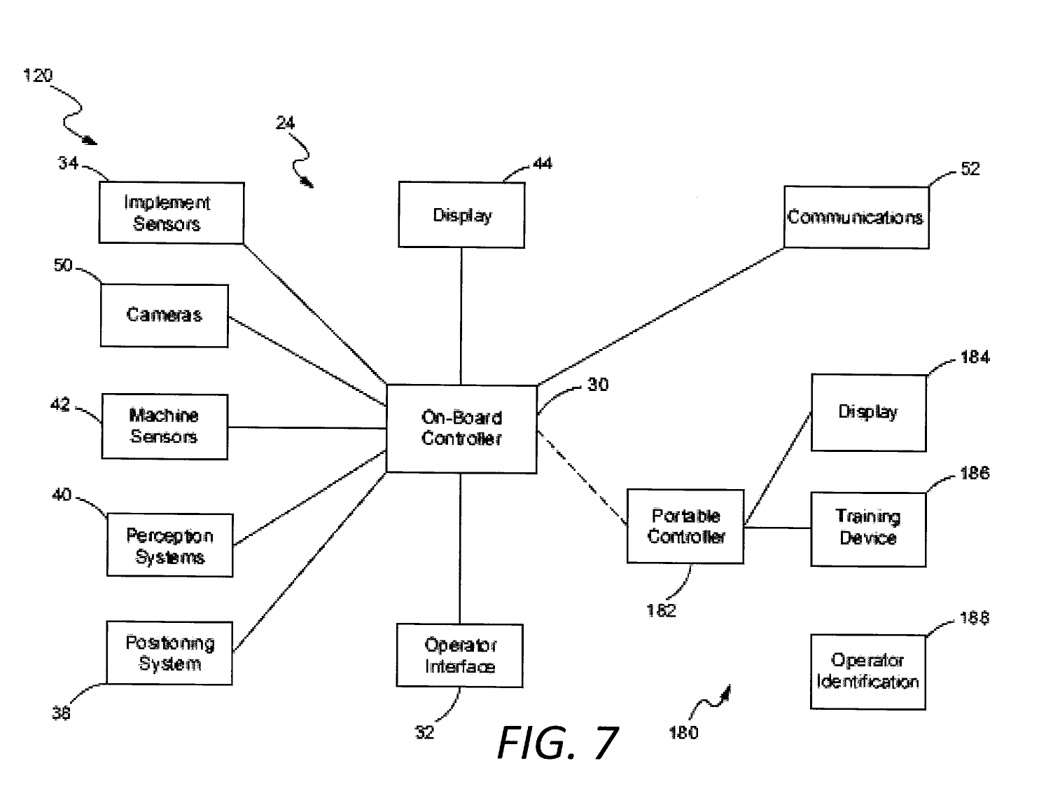

Referring now to FIG. 7, according to another embodiment of the present disclosure, the system 120 comprises a portable apparatus 180 that is not integral to the machine 24. The portable apparatus 180 includes a controller 182 in communication with a display 184, a training device 186 containing the coaching point detection algorithm, and an operator identification device 188 for the operator to identify himself, in this aspect. The controller 182 of the portable apparatus 180 may be operatively configured to communicate with the controller 30 of the machine 24. Algorithms or sets of instructions for monitoring operator performance, detecting types of operations being performed and coaching points, comparing actual real-time data to expected data, displaying real-time views, and providing coaching information may be preprogrammed into a memory of the controller 182, training device 186, or a display module of the display 184, as described above with the controller 30 and display module 48.

Thus, when connected to the machine 24, the controller 182 of the portable apparatus 180 uses and collects data from the controller 30 and other parts (e.g., operator interface 32, implement sensors 34, machine sensors 36, positioning system 38, perception systems 40, and cameras 50) of the machine 24 in order to monitor an operation of the machine and provide coaching to the operator in real-time. The other features described above with regard to the system 20 and controller 30 may also be incorporated into the portable apparatus 180.

In an embodiment, the system 20 includes communications systems 52, which connect to off-board components, such as through cellular, Wi-Fi, or other wired or wireless communications protocols. The controller 30 may transmit data related to the operator's performance and associated coaching information to an off-board location via the communications systems 52, where the operator may later observe his actions compared to proper operating methods, or a manager of the operator can review the operator's performance.

In an example of an operator controlling a wheel loader 22, as shown in FIG. 3, to dig into a pile, the controller 30 receives actual data from the operator interface, implement sensors, machine sensors, positioning system, and perception systems. Based on the actual data, the controller 30 determines the type of operation being performed, i.e., digging into a pile. For example, from signals sent by the perception systems, the controller 30 can determine that the wheel loader is approaching a pile of material. From signals sent by the positioning system, the controller 30 can determine a GPS location of the wheel loader relative to the pile. From signals sent by the operator interface, the controller 30 can detect commands to lift a linkage and the bucket. From signals sent by the implement sensors (e.g., pressure sensor in the bucket), the controller 30 can determine that material is being loaded into the bucket; and from signals sent by the machine sensors, the controller 30 can determine an engine speed and transmission gear. Based on a combination of this data, the controller 30 detects that the wheel loader 22 is digging into a pile.

Once the controller 30 determines that the wheel loader 22 is digging into a pile, the controller 30 compares the actual data from the operation to the expected data for this operation. For example, the controller 30 can check for various coaching points related to digging and compare the actual data to the expected data. One coaching point related to digging into a pile may be to assure that there is no machine articulation. When the controller 30 determines that the wheel loader is digging, the coaching point detection algorithm monitors the articulation angle of the wheel loader 22. The articulation angle may be detected by the machine sensors (e.g., cylinder position sensor or articulation joint sensor) and sent to the controller 30. The coaching point detection algorithm then compares the detected or actual articulation angle to expected data for the articulation angle while digging. For example, the expected data for the articulation angle while digging may be between negative fourteen degrees (−14°) and fourteen degrees (14°) according to a model operating method for the wheel loader. Other values for the expected data parameters for the articulation angle are certainly possible.

If the actual articulation angle is outside the expected data, e.g., greater than fourteen degrees (14°) or less than negative fourteen degrees (−14°) then the operator did not perform according to the model operating method and the controller 30 notes the operation as a coaching opportunity.

In another example where the machine is an articulated truck 21 as shown in FIG. 4, the controller 30 can determine the type of operation being performed based on the actual data received, e.g., carrying and dumping a payload. For example, from signals sent by the implement sensors (e.g. payload weight sensor in the dump body), the controller 30 can determine there is a payload in the dump body. From signals sent by the operator interface, the controller 30 can determine commands to reverse the truck, stop the truck, and lift the dump body. From signals sent by the machine sensors, the controller 30 can determine an engine speed and transmission gear. From signals sent by the perception systems, the controller 30 can detect the dump location (e.g. a cliff or wall of the dump location). From signals sent by the positioning system, the controller 30 can determine a GPS location of the truck relative to the dump location. Based on a combination of this data, the controller 30 detects that the truck is carrying and dumping the payload onto the dump location.

Once the controller 30 determines that the dump truck 21 is carrying and dumping the payload onto the dump location, the controller 30 compares actual data to expected data for carrying and dumping. For example, the controller 30 can check for various coaching points related and compare actual data to expected data.

One example coaching point when carrying and dumping the payload is proper positioning of the truck relative to the dump location. Expected data for an optimal positioning of the truck to the dump location may be about five meters (5 m) to eight meters (8 m) from a back edge of the truck to the wall of the dump location. Other distances and configurations are certainly possible. The controller 30 detects the actual distance from the back edge of the truck to the wall (via signals from the positioning system) when an engine of the truck is idle (via signals for machine speed or transmission gear from the machine sensors) and the operator inputs the command to lift the dump body (via signals from the operator interface). The controller 30 then compares the actual distance when dumping to the expected distance.

If the actual distance between the back edge of the truck and the wall of the dump location is less than five meters (5 m) or greater than eight meters (8 m) during the operation, then the controller 30 can note the operation as a coaching opportunity for later coaching.

Such later coaching may include, for example, a top view of the truck relative to the dump location, or an enlarged side view of the back edge of the truck relative to the wall of the dump location, with superimposed graphics for a correlation to expected data, e.g., a color scheme representing a relationship between the actual distance and expected distance or arrows guiding the operator to a distance of five to eight meters (5-8 m) between the back edge and wall.

Furthermore, the coaching information may be presented in the form of a simulation, a video, a text, an automated demonstration onboard the machine, an audio description, or a combination thereof. Moreover, a view of a linkage or other element of the machine can be displayed along with visual feedback for coaching the operator toward a proper technique.

As noted above, the system prioritizes the collected list of coaching points for review by the operator in an order of importance and can decide which form of coaching is best suited for each coaching point. With respect to priority, example factors considered by the controller 30 include the number of occurrences of a particular coaching opportunity (measured historically or during a given session), a severity of error in the coachable action, the impact of errors on machine productivity, and the impact of errors on machine performance.

Thus, consider the example of a wheel loader 22 that has performed a number of operations during a work session including (1) digging into a pile without setting the wheels and with a frame articulation exceeding 14 degrees and (2) raising the loaded bucket to an inappropriate height while transferring the material. When the work session is done, the controller 30 may prioritize the presentation of coaching based on safety or productivity. For priority based on safety before productivity, the coaching points may be ordered as: (1) coaching the operator to limit the height of the loaded bucket to lower than the cab top, (2) coaching the operator to set the wheels, and (3) coaching the operator not to articulate the frame while digging. Alternatively, when prioritized to emphasize productivity, the coaching points may be ordered as: (1) coaching the operator to set the wheels, (2) coaching the operator not to articulate the frame while digging, and (3) coaching the operator to limit the height of the loaded bucket to lower than the cab top.

### INDUSTRIAL APPLICABILITY

In general, the principles of the present disclosure find utility in various industrial applications, such as in earthmoving, industrial, construction and agricultural machines. In particular, the disclosed operator coaching system and method may be applied to excavators, wheel loaders, track-type tractors, motor graders, articulated trucks, pipe layers, backhoes, and the like. By applying the disclosed system and method to a machine, the operator's performance may be monitored and coaching may be provided based on the operator's performance. For example, the controller of the system can detect operations needing improvement, and thus identify and prioritize coaching opportunities.

With respect to the format in which coaching is provided to the operator, the controller 30 and display module 42 may provide a view of the machine 22 operation as it was actually executed together with simulated graphics coaching the operator toward the predetermined action in accordance with the model operation. The view of the machine may be annotated or superimposed with simulated computer graphics including, but not limited to, arrows, numbers, words, colors, and the like.

According to one aspect, the relationship between the actual and expected actions is displayed through a color scheme. For example, the display 46 may show a green color superimposed on the view of a linkage, if the actual data for a position, angle, etc. of the linkage is within the expected data. The display 46 may show a red color superimposed on the view of the linkage, if the actual data for the position, angle, etc. of the linkage is outside of the expected data. The colors on the display may change depending on whether the actual action is moving toward or moving away from the expected action. The color scheme may guide the operator via the display 46 to show the expected action.

Similarly, a gradient of colors, e.g., ranging from green to red (e.g., green, yellow, orange, red) may be superimposed on the real-time view of the linkage to depict a magnitude of the relationship between the actual action and the predetermined action. A green-colored zone may be associated with the expected data, while a yellow-colored zone, an orange-colored zone, and a red-colored zone 68 may be shown on the display 46 to indicate divergence from the expected data of the model operating method.

The coaching information may be provided to the operator through different forms of coaching, e.g., a simulation, a video, a text, an automated demonstration onboard the machine 22, an audio description, or a combination thereof. The simulation may include the computer graphics simulated view of the machine 22 described above, along with the color scheme representation of the relationship between the actual operation and the model operation, or a simulation of the operator's action synchronized and side-by-side with the predetermined action. The video may include a captured view of the machine 24 using the cameras 50, along with the color scheme described above, or a view of the machine synchronized and side-by-side with a recorded video of the predetermined action. The text may include written instructions on how to perform in accordance with predetermined actions, or may refer to a manual of operation specific to the machine 22.

An automated demonstration may entail the controller 30 controlling the machine 22 and performing an action or operation for the operator to observe. The audio description may describe the predetermined action or proper techniques for operation, or may describe errors of the operator's performance, the effect of those errors and how to correct them. The combination of coaching forms may include the simulation synchronized with the audio description, the video synchronized with the audio description, the text shown on the display 46 while also communicated audibly through a speaker, the automated demonstration synchronized with the audio description, or the like.

In one aspect, the controller 30 sends a signal to the output device 42 prompting the operator for input as to which form of coaching to provide, either with respect to a given coaching opportunity or with respect to all coaching opportunities. The operator can then personally select their preferred coaching form. Alternatively, the controller 30 can determine in which form to provide the coaching information to the operator.

The coaching point detection algorithm 44 may include the coaching form to provide based on each coaching point, as preprogrammed into a memory associated with the controller 30. For example, in the example coaching point for the track-type tractor 23 (FIG. 2) of using proper gears when dozing and push loading, an audio description or a text informing the operator which gear to use may be automatically provided to the operator, instead of, for example, an automated demonstration (or the option for an automated demonstration).

According to another aspect, while monitoring the operator's performance, the controller 30 can flag and store in memory, the received data, time, simulations, captured videos, list of suggested topics, or any other information necessary for coaching the operator during the later coaching session. Thus, the operator may review his or her performance, coaching points, notifications, coachable actions, conforming actions, coaching information, etc. when he is not operating the machine 22, such as, when the engine is idle, at an end of his shift, or at a beginning of his next performance.

As noted above, the coaching point detection algorithm 44 includes a predetermined or programmable priority for the various coaching points. In an embodiment, the controller 30 thus prioritizes the coaching points using a number of factors, including, for example, a number of occurrences of a particular coaching opportunity (measured historically or during a given session), a severity of the error in the coachable action, the impact of errors on machine productivity, and the impact of errors on machine performance.

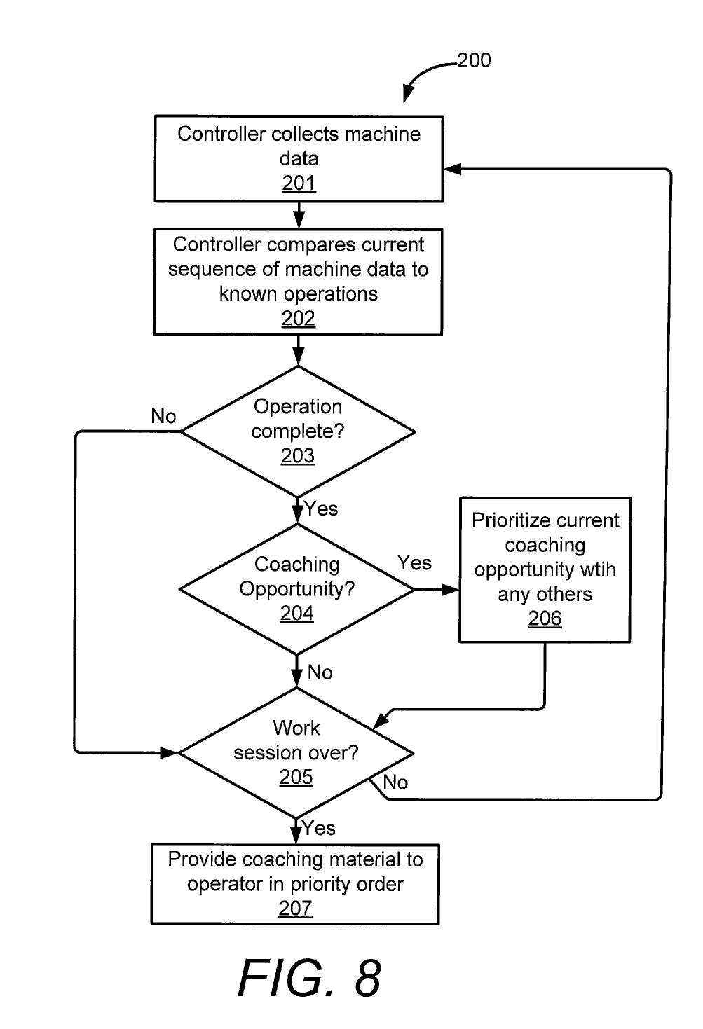

With respect to the process executed by the controller 30 for coaching an operator, FIG. 8 shows a flowchart outlining a coaching method according to an embodiment of the present disclosure. At a first stage 201 of the process 200, the controller 30 collects machine data, including user input data from the sensors and interfaces discussed above for example. The process 200 then flows to stage 202, wherein the controller 30 compares a current sequence of machine data to expected machine data for known operations. At stage 203, the controller determines based on this comparison whether the current operation is complete.

In matching the current operation to a known operation via a collection of data or parameters, there need not be an exact match, and indeed a fairly rough match will suffice. For example, an operator may perform an operation that meets basic parameters of a known model operation such as location (adjacent a pile), implement operation (bucket partially raised) drive characteristics (machine drives forward, encounters resistance, spins wheels), but that fails to precisely meet the parameters associated with the model operation (bucket at x height, machine drives forward, begins to encounter resistance, raises bucket, hydraulic pressure in lift cylinders rises sharply, wheels do not spin). The extent to which the actual data is a mismatch to the model data will determine if the actual operation is (a) not the same operation, (b) the same operation but erroneously executed, or (c) the same operation and well-executed. To this end, a first threshold may establish that the operation is indeed the same operation, while a second and closer threshold will determine if the operation was well-executed.

If at stage 203 it is determined that the current sequence of machine data indicates completion of a known operation, the process continues to stage 204, wherein the controller 30 determines whether the operation was erroneously executed, i.e., whether it presents a coaching opportunity. If so, the coaching opportunity is stored and prioritized with respect to any previously identified coaching opportunities at stage 206 and the process 200 flows to stage 205.

If at stage 203 it was determined that the current sequence of machine data does not yet correspond to a known operation, or if at stage 204 it was determined that the completed operation does not present a coaching opportunity (i.e., it was well-executed), then the process 200 skips to stage 205 as well.

At stage 205, the controller determines whether the current work session is complete. As noted above, this may entail determining that the machine has been at zero speed, idling in neutral for a predetermined period. Alternatively, the operator may provide an indicator that the work session is complete, e.g., by releasing pressure in one or more hydraulic systems associated with the machine, engaging a park brake, or some other action.

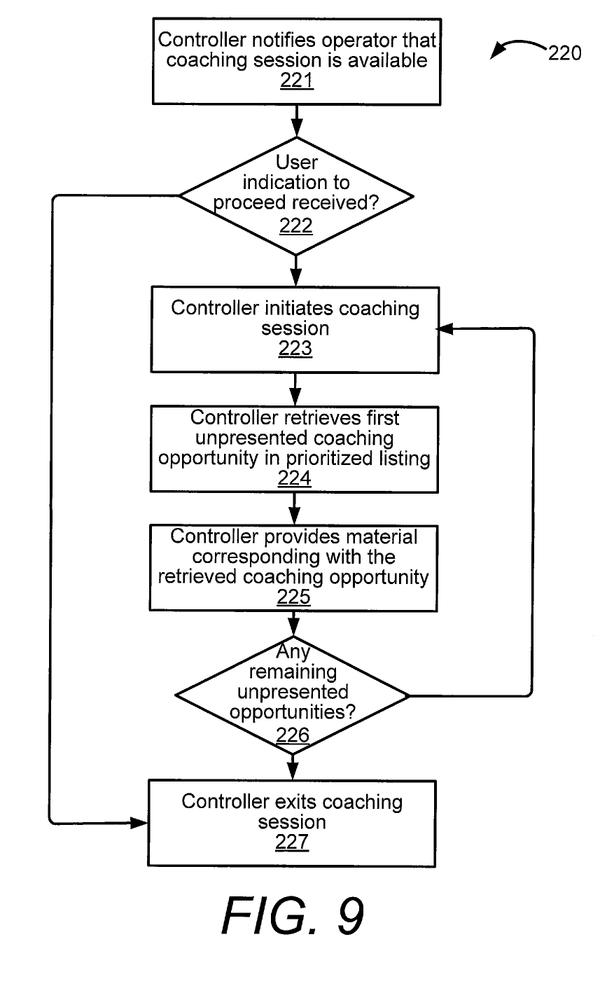

If the work session is not over, the process 200 returns to stage 201. Otherwise, the process 200 moves to stage 207, wherein the controller provides prioritized coaching to the operator. The process of presenting coaching materials in a prioritized manner is discussed in greater depth with reference to the process 220 of FIG. 9.

At stage 221 of the process 220, the controller 30 notifies the operator that a coaching session for the work session just finished is available. At stage 222, if a user indication to proceed is received (e.g., via a button push, icon selection, or other user interface indicator), the process 220 flows to stage 223, wherein the controller 30 initiates the coaching session.

The controller 30 retrieves the first unpresented coaching opportunity in the prioritized listing of coaching opportunities at stage 224 and provides textual, graphical, audible, and or simulated material corresponding with the retrieved coaching opportunity at stage 225. At stage 226, the controller 30 determines whether there are any remaining unpresented coaching opportunities in the prioritized listing, and if so, the process 220 returns to stage 224. If instead the coaching opportunity just presented was the last remaining unpresented coaching opportunity in the prioritized listing of coaching opportunities, the process 220 flows from stage 227 whereupon it exits.

While the foregoing detailed description has been given and provided with respect to certain specific embodiments, it is to be understood that the scope of the disclosure should not be limited to such embodiments, but that the same are provided simply for enablement and best mode purposes. The disclosed principles are broader than the embodiments specifically disclosed.

While some features are described in conjunction with certain specific embodiments, these features are not limited to use with only the embodiment with which they are described, but instead may be used together with or separate from, other features disclosed in conjunction with alternate embodiments of the invention.

What is claimed is:

1. A method for coaching an operator of a machine having a controller in communication with a plurality of sensors, each configured to provide a data signal indicative of a parameter associated with an operation of the machine, and an operator interface configured to provide operator signals for manipulating the machine, the method comprising:
receiving a data signal from one or more of the plurality of sensors at the controller;
receiving one or more operator signals from the operator interface at the controller;
identifying at the controller a machine operation performed based on the received data signals and the received operator signals;
comparing, at the controller, the received data signals and the received operator signals with expected data signals and operator signals for the operation based on a model of the operation; and
identifying the operation as a coaching opportunity based on the step of comparing, and assigning a priority to each coaching opportunity for later presentation to the operator.

2. The method of claim 1, wherein flagging the operation as a coaching opportunity based on the step of comparing comprises determining that one or more of the received data signals and received operator signals differ substantially from one or more corresponding expected data signals and operator signals.

3. The method of claim 2, wherein determining that one or more of the received data signals and received operator signals differ substantially from one or more corresponding expected data signals and operator signals comprises determining that the one or more of the received data signals and received operator signals differs from one or more corresponding expected data signals and operator signals by more than a predetermined threshold amount.

4. The method of claim 1, further comprising determining that a work session during which the operation was performed has ended, and presenting coaching materials to the operator in an order determined by the assigned priority of each coaching opportunity.

5. The method of claim 4, wherein assigning a priority to each coaching opportunity includes assigning each coaching opportunity a priority based on machine productivity.

6. The method of claim 4, wherein assigning a priority to each coaching opportunity includes assigning each coaching opportunity a priority based on machine operational efficiency.

7. The method of claim 4, wherein assigning a priority to each coaching opportunity includes assigning each coaching opportunity a priority based on machine safety.

8. The method of claim 4, further comprising receiving a priority selection and wherein assigning a priority to each coaching opportunity includes assigning a priority to at least one coaching opportunity based on the priority selection.

9. The method of claim 4, wherein assigning a priority to each coaching opportunity includes assigning a priority to at least one coaching opportunity based on a number of times that the operator has erroneously performed the at least one operation.

10. The method of claim 4, wherein assigning a priority to each coaching opportunity includes assigning each coaching opportunity a priority based on a coaching history of the operator with respect to the operation by assigning a higher priority to one or more operations for which the operator has previously been coached.

11. The method of claim 4, wherein presenting the coaching materials to the operator comprises presenting to the operator one or more of a simulation, a video, a textual message, an automated demonstration, and an audio description.

12. The method of claim 4, wherein presenting the coaching materials to the operator comprises presenting to the operator a computer-simulated view of a linkage of the machine based on at least one of the received signals and the expected signals for the operation.

13. A system for coaching an operator of an industrial machine, comprising:
a plurality of sensors associated with the machine, each sensor being configured to generate a machine data signal indicative of the operation of an element of the machine;
an output device configured to present information to an operator of the machine; and
a controller in communication with the output device and with the plurality of sensors, the controller configured to:
receive the machine data signals and identify a machine operation based on the received machine data signals;
compare the received machine data signals to expected machine data associated with a model of the operation;
identify the operation as having been erroneously performed based on the comparison, and record the erroneously performed operation as a coaching opportunity;
assign a priority to each of a plurality of coaching opportunities; and
present coaching material associated with each coaching opportunity via the output device in an order defined by the assigned priorities.

14. The system for coaching an operator of an industrial machine according to claim 13, wherein the controller is configured to identify the operation as having been erroneously performed based on the comparison by determining that one or more of the received machine data signals differ substantially from corresponding expected machine data.

15. The system for coaching an operator of an industrial machine according to claim 13, wherein the controller is configured to determine that one or more of the received machine data signals differ substantially from corresponding expected machine data by determining that the one or more of the received machine data signals differ from the corresponding expected machine data by more than a predetermined threshold amount.

16. The system for coaching an operator of an industrial machine according to claim 13, wherein the controller is configured to assign a priority to each of the plurality of coaching opportunities based on one or more of machine productivity, machine operational efficiency, and machine safety.

17. The system for coaching an operator of an industrial machine according to claim 13, wherein the controller is further configured to receive a priority selection and to assign a priority to each of the plurality of coaching opportunities based on the priority selection.

18. The system for coaching an operator of an industrial machine according to claim 13, wherein the controller is configured to assign a priority to each of the plurality of coaching opportunities based on one of a number of times that the operator has erroneously performed each operation and a number of times that the operator has previously been coached regarding each operation.

19. A non-transitory computer-readable medium having stored thereon computer-executable instructions for coaching an operator of a machine having a controller in communication with a plurality of sensors, each configured to provide a data signal indicative of a parameter associated with an operation of the machine, and an operator interface configured to provide operator signals for manipulating the machine, the computer-executable instructions including instructions for:
receiving a data signal from one or more of the plurality of sensors at the controller;
receiving one or more operator signals from the operator interface at the controller;
identifying at the controller a machine operation performed based on the received data signals and the received operator signals;
comparing, at the controller, the received data signals and the received operator signals with expected data signals and operator signals for the operation based on a model of the operation;
identifying the operation as a coaching opportunity based on the step of comparing;
assigning a priority to each coaching opportunity; and
detecting that a work session involving the machine has ended and in response, presenting coaching materials associated with each coaching opportunity to the user in an order defined by the assigned priority.

20. The non-transitory computer-readable medium in accordance with claim 19, wherein the instructions for assigning a priority to each coaching opportunity
